(19) United States
(12) Patent Application Publication
(10) Pub. No.: US 2022/0383223 A1
(43) Pub. Date: Dec. 1, 2022

(54) VENDOR PROFILE DATA PROCESSING AND MANAGEMENT

(71) Applicants: Tasneem C. Manjra, Danville, CA (US); Faruk H. Abdullah, Danville, CA (US)

(72) Inventors: Tasneem C. Manjra, Danville, CA (US); Faruk H. Abdullah, Danville, CA (US)

(21) Appl. No.: 17/804,465

(22) Filed: May 27, 2022

Related U.S. Application Data
(60) Provisional application No. 63/202,177, filed on May 28, 2021.

(51) Int. Cl. G06Q 10/06; G06F 16/955

(52) U.S. Cl. CPC G06Q 10/06375; G06Q 10/06393; G06F 16/955

(57) ABSTRACT

Various embodiments include systems, methods, and non-transitory computer-readable media for managing vendor profiles. Consistent with these embodiments, a method includes receiving a request to transmit a negotiation invitation to a vendor, generating a Uniform Resource Locator (URL) based on the request, transmitting the URL to the vendor via an email, receiving a return value of the negotiation item from the vendor via the web-based entry element, causing presentation of the return value of the negotiation item on a user interface of a device, and generating a vendor profile based at least on the negotiation item and the return value of the negotiation item.

### CROSS-REFERENCE TO RELATED APPLICATION

This application claims priority to and the benefit of U.S. Provisional Patent Application No. 63/202,177, filed on May 28, 2021, which is incorporated herein by reference.

### TECHNICAL FIELD

The present disclosure generally relates to data processing and management. In particular, various embodiments described herein provide systems, methods, techniques, instruction sequences, and devices that facilitate vendor profile data processing and management.

### BACKGROUND

Existing logistics management systems face the challenges of optimizing supply chains, including efficiently managing vendor profiles and monitoring various concurrent activities with multiple vendors in multiple stages across categories of products, services, or projects. Further challenges include providing users, such as retailers or manufacturers, with technical tools for vendor performance data analysis and rating to allow them to make informed operational decisions based on vendors' performance.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of example, and not limitation, in the figures of the accompanying drawings.

FIG. 1 is a block diagram showing an example networked environment that includes a vendor profile management system, according to various embodiments of the present disclosure.

FIG. 2 is a block diagram illustrating an example vendor profile management system, according to various embodiments of the present disclosure.

FIG. 3 is a flowchart illustrating an example method for managing vendor profiles, according to various embodiments of the present disclosure.

FIG. 4 is a flowchart illustrating an example method for managing vendor profiles, according to various embodiments of the present disclosure.

FIG. 5 illustrates an example graphical user interface generated by an example vendor profile management system during operation, according to various embodiments of the present disclosure.

FIG. 6 illustrates an example graphical user interface generated by an example vendor profile management system during operation, according to various embodiments of the present disclosure.

FIG. 7 illustrates an example graphical user interface generated by an example vendor profile management system during operation, according to various embodiments of the present disclosure.

FIG. 8 is a block diagram illustrating a representative software architecture, which may be used in conjunction with various hardware architectures herein described, according to various embodiments of the present disclosure.

FIG. 9 is a block diagram illustrating components of a machine able to read instructions from a machine storage medium and perform any one or more of the methodologies discussed herein according to various embodiments of the present disclosure.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide a thorough understanding of embodiments. It will be evident, however, to one skilled in the art that the present inventive subject matter may be practiced without these specific details.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various embodiments may be given throughout this description. These are merely descriptions of specific embodiments. The scope or meaning of the claims is not limited to the embodiments given.

Existing systems face the challenges of optimizing supply chains, including efficiently managing vendor profiles and monitoring various activities that occur concurrently with multiple vendors. Activities may include rounds of bidding negotiations in different stages across categories of products, services, or projects. Further challenges include providing users, such as retailers or manufacturers, with vendor performance data analysis, rating, and filtering tools to allow them to make informed decisions based on vendors' performance.

Various examples include systems, methods, and non-transitory computer-readable media for managing vendor profiles, including facilitating bid negotiation activities, generating and updating vendor profiles (also referred to as portfolios) based on historical and ongoing bid negotiations, vendor performance, contract terms, etc. A vendor profile may include vendor identification information, bid negotiation history, the amount of total spent and savings, the number of contracts, vendor ratings, etc. A vendor profile may be updated in real time based on activities monitored by a vendor profile management system. Contract terms may include a number of contract items, including, without limitation: master number, description, unit number, goal price, anchor price (e.g., lowest acceptable price), etc. Bid negotiation activities may include, without limitation: creating a bid sheet that includes one or more negotiation items, transmitting the bid sheet to one or more vendors of selection, receiving counter-offer negotiation items, accepting a bid sheet with updated negotiation items, and generating contracts based on the accepted negotiation items, and providing bidding tracking for one or more vendors, etc.

In various embodiments, the vendor profile management system receives a request to transmit a negotiation invitation to a vendor. The request includes information that describes a negotiation item. The vendor profile management system generates a Uniform Resource Locator (URL) based on the request. The URL is associated with a web resource that includes a web-based entry element. The vendor profile management system transmits the URL to the vendor via an email and receives a return value of the negotiation item from the vendor via the web-based entry element. The return value of the negotiation item may be a counter-offer negotiation item proposed by the vendor. The vendor profile management system causes a presentation of the return value of the negotiation item on a user interface of a device.

In various embodiments, the vendor profile management system may generate a vendor profile based at least on the negotiation item and the return value of the negotiation item. If the vendor profile management system determines a profile has already been created for a specific vendor, the vendor profile management system may update the vendor profile to provide users with the most up-to-date activity status and vendor performance analysis.

In various embodiments, the vendor profile management system receives historical data that includes a plurality of historical negotiation items associated with the vendor. The historical data may be received (or fetched) from an internal or an external system communicatively coupled to the vendor profile management system. The historical data may be presented in spreadsheet objects, such as Excel cells, ranges, rows, columns, sheets, etc. The vendor profile management system may generate and/or update the vendor profiles based on the historical data.

In various embodiments, the vendor profile management system may generate one or more reports based on one or more vendor profiles. A report may include, without limitation: information that describes a negotiation history of one or more projects, products, and/or services associated with the vendor; ongoing or historical negotiation terms; vendor contact information; vendor performance ratings, status of negotiations (e.g., pending or completed), and resulting savings, etc. The vendor profile management system may generate a visual and data-driven presentation of such information in graphs, charts, or diagrams and cause them to be displayed in a report on the user interface of the device.

In various embodiments, the vendor profile management system may dynamically update the vendor profile and the report based on a further negotiation invitation transmitted to the vendor and a further return value of a further negotiation item received from the vendor. The vendor profile management system may dynamically cause the presentation of an updated vendor profile or an updated report on the user interface of the device. In various embodiments, the content of the report can be customized by the user to include at least one of: one or more ratings of the vendor and a number of awarded contracts, an amount of total savings, and an amount of total spending. The ratings of vendors may be generated based on user input or based on data analysis performed by the vendor profile management system.

In various embodiments, the vendor profile management system may receive a user input that includes a tag representing a characteristic of the vendor. The vendor profile management system may identify a vendor profile associated with the vendor and associate the tag with the vendor profile.

In various embodiments, the vendor profile management system may receive a request to search for all vendors that share a common characteristic and generate a list of vendors (e.g., the first list of vendors) based on the tag representing the common characteristic. The vendor profile management system may cause the presentation of the list of vendors on a user interface of the device.

In various embodiments, the vendor profile management system may generate a user interface (e.g., the second user interface) on the device. The second user interface includes a set of entry elements, such as web-based entry elements. Each of the set of entry elements is configured to receive a filter criterion of one or more negotiation events. The vendor profile management system may receive a user input (e.g., the first user input) that includes a value of a filter criterion (e.g., the first filter criterion) via the entry element from the set of entry elements.

In various embodiments, the vendor profile management system may generate a set of negotiation events (e.g., the first set of negotiation events). The generation of the set of negotiation events includes filtering all negotiation events based on the entered first filter criterion. The vendor profile management system may then cause the presentation of the set of negotiation events on the user interface (e.g., the second user interface) on the device.

In various embodiments, the vendor profile management system may receive from one or more vendors further negotiation items, such as available inventory items and the associated prices. As a result, a user of the vendor profile management system may compare multiple vendors based on these received further negotiation items when making contract awarding decisions.

Reference will now be made in detail to embodiments of the present disclosure, examples of which are illustrated in the appended drawings. The present disclosure may, however, be embodied in many different forms and should not be construed as being limited to the embodiments set forth herein.

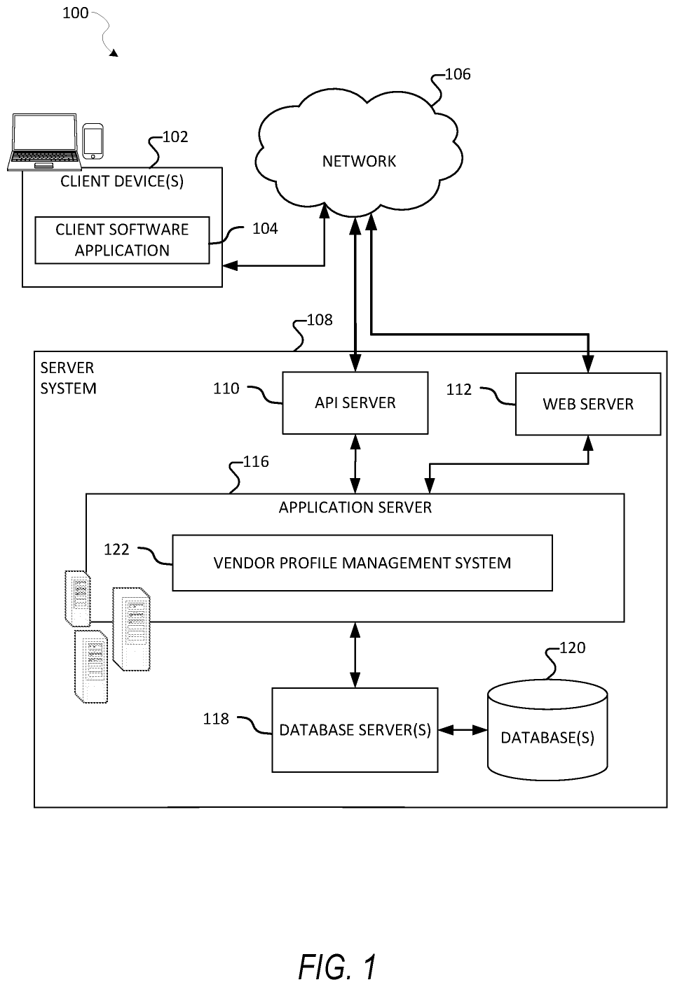

FIG. 1 is a block diagram showing an example networked environment 100 that includes a vendor profile management system, according to various embodiments of the present disclosure. By including the vendor profile management system 122, the networked environment 100 can facilitate vendor profile data processing and management as described herein. In particular, a user at the client device 102 can access the vendor profile management system 122 (e.g., via a graphical user interface presented on a software application on the client device 102) and use the vendor profile management system 122 to manage vendor profiles, including facilitating bid negotiation activities, generating and updating vendor profiles based on historical and ongoing bid negotiations, vendor performance, contract terms, etc.

As shown, the networked environment 100 includes one or more client devices 102, a server system 108, and a network 106 (e.g., including the Internet, wide-area-network (WAN), local-area-network (LAN), wireless network, etc.) that communicatively couples them together. Each client device 102 can host a number of applications, including a client software application 104. The client software application 104 can communicate data with the server system 108 via a network 106. Accordingly, the client software application 104 can communicate and exchange data with the server system 108 via network 106.

The server system 108 provides server-side functionality via the network 106 to the client software application 104. While certain functions of the networked environment 100 are described herein as being performed by the vendor profile management system 122 on the server system 108, it will be appreciated that the location of certain functionality within the server system 108 is a design choice. For example, it may be technically preferable to initially deploy certain technology and functionality within the server system 108, but to later migrate this technology and functionality to the client software application 104 where the client device 102 manages vendor profiles.

The server system 108 supports various services and operations that are provided to the client software application 104 by the vendor profile management system 122. Such operations include transmitting data from the vendor profile management system 122 to the client software application 104, receiving data from the client software application 104 to the vendor profile management system 122, and the vendor profile management system 122 processing data generated by the client software application 104. This data may include, for example, requests and responses relating to bid negotiations, vendor identification information, bid negotiation history, the amount of total spent and savings, the number of contracts, vendor ratings, etc. Data exchanges within the networked environment 100 may be invoked and controlled through operations of software component environments available via one or more endpoints, or functions available via one or more user interfaces of the client software application 104, which may include web-based user interfaces provided by the server system 108 for presentation at the client device 102.

With respect to the server system 108, each of an Application Program Interface (API) server 110 and a web server 112 is coupled to an application server 116, which hosts the vendor profile management system 122. The application server 116 is communicatively coupled to a database server 118, which facilitates access to a database 120 that stores data associated with the application server 116, including data that may be generated or used by the vendor profile management system 122.

The API server 110 receives and transmits data (e.g., API calls, commands, requests, responses, and authentication data) between the client device 102 and the application server 116. Specifically, the API server 110 provides a set of interfaces (e.g., routines and protocols) that can be called or queried by the client software application 104 in order to invoke functionality of the application server 116. The API server 110 exposes various functions supported by the application server 116 including, without limitation: user registration; login functionality; data object operations (e.g., generating, storing, retrieving, encrypting, decrypting, transferring, access rights, licensing, etc.); and user communications.

Through one or more web-based interfaces (e.g., web-based user interfaces), the web server 112 can support various functionality of the vendor profile management system 122 of the application server 116.

The application server 116 hosts a number of applications and subsystems, including the vendor profile management system 122, which supports various functions and services with respect to various embodiments described herein. The application server 116 is communicatively coupled to a database server 118, which facilitates access to database(s) 120 that stores data associated with the vendor profile management system 122.

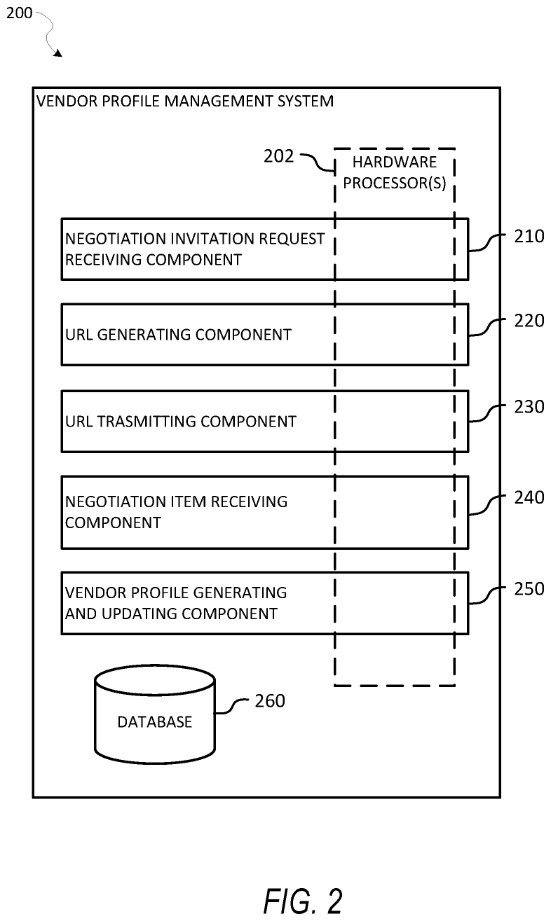

FIG. 2 is a block diagram illustrating an example vendor profile management system 200, according to various embodiments of the present disclosure. For some embodiments, the vendor profile management system 200 represents an example of the vendor profile management system 122 described with respect to FIG. 1. As shown, the vendor profile management system 200 comprises a negotiation invitation request receiving component 210, an URL generating component 220, an URL transmitting component 230, a negotiation item receiving component 240, and a vendor profile generating and updating component 250. According to various embodiments, one or more of the negotiation invitation request receiving component 210, the URL generating component 220, the URL transmitting component 230, the negotiation item receiving component 240, and the vendor profile generating and updating component 250 are implemented by one or more hardware processors 202. Data generated by one or more of the negotiation invitation request receiving component 210, the URL generating component 220, the URL transmitting component 230, the negotiation item receiving component 240, and the vendor profile generating and updating component 250 is stored in a database 260 of the vendor profile management system 200.

In various embodiments, the negotiation invitation request receiving component 210 is configured to receive one or more requests to transmit one or more negotiation invitations to one or more vendors. A request includes data that describes (or represents) one or more negotiation items.

In various embodiments, the URL generating component 220 is configured to generate a Uniform Resource Locator (URL) based on the request. The URL may be associated with a web resource (e.g., webpage) that includes a web-based entry element configured to receive one or more user inputs.

In various embodiments, the URL transmitting component 230 is configured to transmit the URL to one or more vendors via one or more emails, or messages (e.g., text messages), in some instances.

In various embodiments, the negotiation item receiving component 240 is configured to receive one or more return values of the one or more negotiation items from the one or more vendors via the one or more web-based entry elements. A return value of a negotiation item may be a counter-offer negotiation item proposed by a vendor. The negotiation item receiving component 240, or any of the components mentioned herein, is configured to cause a presentation of the return value of the negotiation item on a user interface of a device.

In various embodiments, the vendor profile generating and updating component 250 is configured to generate a vendor profile based at least on a negotiation item and a return value of the negotiation item. If the vendor profile generating and updating component 250 determines a profile has already been created for a specific vendor, the vendor profile generating and updating component 250 is configured to update the vendor profile to provide users with the most up-to-date activity status and vendor performance analysis.

In various embodiments, the vendor profile generating and updating component 250 is configured to receive historical data that may include a plurality of historical negotiation items associated with a vendor. The historical data may be received (or fetched) from an internal or an external system communicatively coupled to the vendor profile management system. The vendor profile generating and updating component 250 is configured to generate and/or update the vendor profiles based on the historical data.

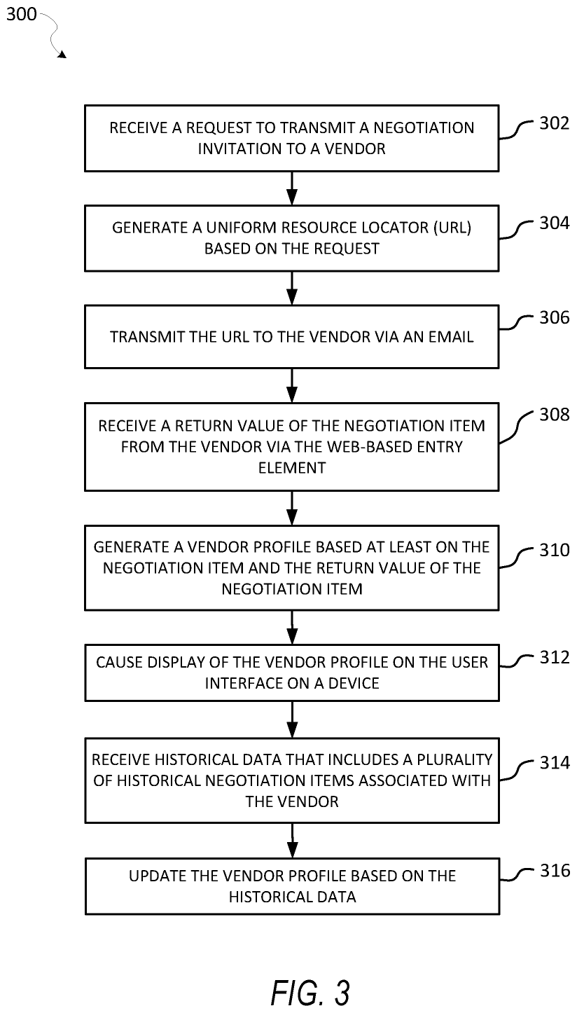

FIG. 3 is a flowchart illustrating an example method 300 for managing vendor profiles, according to various embodiments of the present disclosure. It will be understood that example methods described herein may be performed by a machine in accordance with some embodiments. For example, the method 300 can be performed by the vendor profile management system 122 described with respect to FIG. 1, the vendor profile management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 300 may be represented by executable instructions that, when executed by a processor of a computing device, cause the computing device to perform the method 300. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

At operation 302, a processor receives one or more requests to transmit one or more negotiation invitations to one or more vendors. A request includes data that describes (or represents) one or more negotiation items.

At operation 304, a processor generates a Uniform Resource Locator (URL) based on the request. The URL may be associated with a web resource (e.g., webpage) that includes a web-based entry element configured to receive one or more user inputs.

At operation 306, a processor transmits the URL to one or more vendors via one or more emails, or messages (e.g., text messages), in some instances.

At operation 308, a processor receives one or more return values of the one or more negotiation items from the one or more vendors via the one or more web-based entry elements. A return value of a negotiation item may be a counter-offer negotiation item proposed by a vendor. The processor causes a presentation (or display) of the return value of the negotiation item on a user interface of a device.

At operation 310, a processor generates a vendor profile based at least on a negotiation item and/or a return value of the negotiation item. If the processor determines a profile has already been created for a specific vendor, the processor updates the vendor profile in real time to provide users with the most up-to-date activity status and vendor performance analysis.

At operation 312, a processor causes a presentation (or display) of the vendor profile on a user interface of a device.

At operation 314, a processor receives historical data that may include a plurality of historical negotiation items associated with a vendor. The historical data may be received (or fetched) from an internal or an external system communicatively coupled to the vendor profile management system.

At operation 316, a processor updates the vendor profiles based on the historical data. The historical data may be presented in spreadsheet objects, such as Excel cells, ranges, rows, columns, sheets, etc. Once the historical data is ingested into (or uploaded to) the vendor profile management system, the data presented in spreadsheet objects may be automatically populated to the corresponding sections in one or more vendor profiles and be displayed in one or more reports via a user interface on a device.

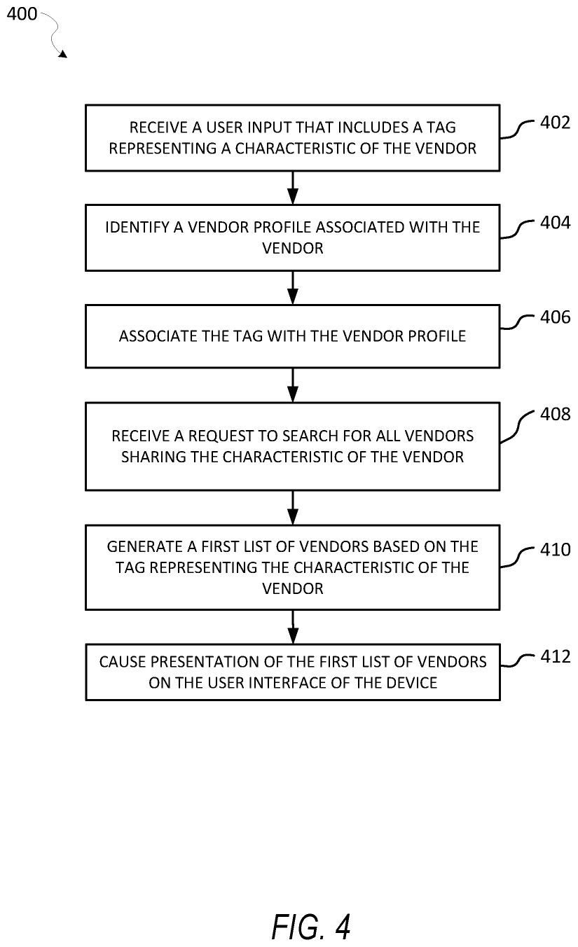

FIG. 4 is a flowchart illustrating an example method 400 for managing vendor profiles, according to various embodiments of the present disclosure. It will be understood that example methods described herein may be performed by a machine in accordance with some embodiments. For example, the method 400 can be performed by the vendor profile management system 122 described with respect to FIG. 1, the vendor profile management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 400 may be represented by executable instructions that, when executed by a processor of a computing device, cause the computing device to perform the method 400. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

At operation 402, a processor receives a user input that includes a tag representing a characteristic of the vendor. Example tags (also referred to as labels) may include, without limitation: “made in the USA,” “minority owned,” “low risk supplier,” “fast shipper,” “women-owned,” “Ontario made,” etc. Users may edit, delete, and create tags, or may select tags from a list of tags pre-generated by the vendor profile management system.

At operation 404, a processor identifies a vendor profile associated with the vendor based on the request.

At operation 406, a processor associates the tag with the identified vendor profile. As a result, when a user searches all vendor profiles associated with the tag, the identified vendor profile will show in a generated list of vendors.

At operation 408, a processor receives a request to search for all vendors that share a common characteristic represented by the tag. For example, the processor may receive a request to list all “fast shippers.”

At operation 410, a processor generates a list of vendors (e.g., the first list of vendors) based on the tag (e.g., “fast shipper”) representing the common characteristic.

At operation 412, a processor causes the presentation (or display) of the list of vendors on a user interface of the device. In various embodiments, the list of vendors may be further filtered based on one or more filtering criteria available for input or selection on the user interface.

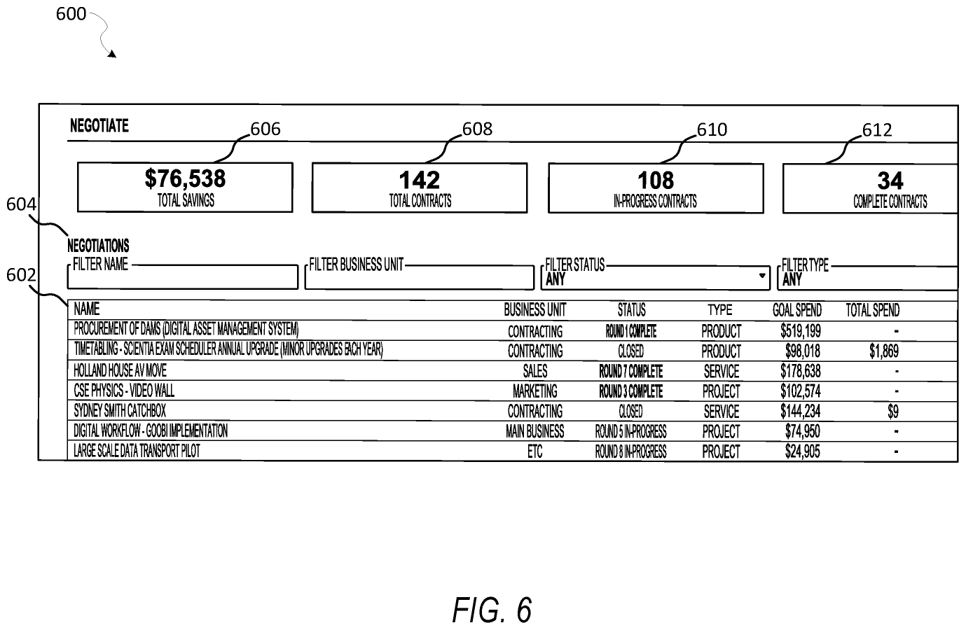

In various embodiments, a processor may generate a user interface (e.g., the second user interface) on the device. The second user interface includes a set of entry elements, such as web-based entry elements, as illustrated in FIG. 6. Each of the set of entry elements is configured to receive a filter criterion of one or more negotiation events. The processor may receive a user input (e.g., the first user input) that includes a value of a filter criterion (e.g., the first filter criterion) via the entry element from the set of entry elements.

In various embodiments, the processor may generate a set of negotiation events (e.g., the first set of negotiation events). The generation of the set of negotiation events includes filtering all negotiation events based on the entered first filter criterion. The vendor profile management system may then cause the presentation of the set of negotiation events on the user interface (e.g., the second user interface) on the device, as illustrated in FIG. 6.

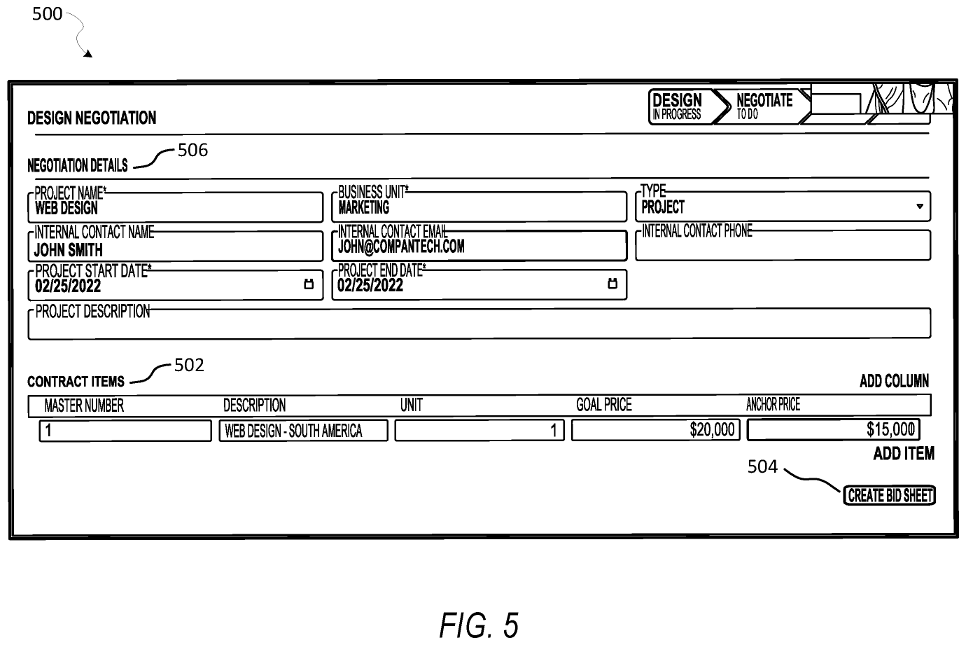

FIG. 5 illustrates an example graphical user interface 500 generated by an example vendor profile management system during operation, according to various embodiments of the present disclosure. As shown, the example graphical user interface 500 includes a number of negotiation details 506 and a number of negotiation items, illustrated as contract terms 502. The contract terms 502 include master number, description, unit number, goal price, anchor price (e.g., lowest acceptable price). Each contract term (or referred to as negotiation item as described herein) may correspond to an entry element that is configured to receive one or more user inputs. For example, as illustrated in FIG. 5, a user may enter value “1” for “unit,” and value “$20,000” for “goal price,” etc. Once a user taps or clicks on button 504 (e.g., “create bid sheet” button), the vendor profile management system may generate a bid sheet to be sent to the vendor under negotiation details 506 via an email using the email address “john@companytech.com”. Upon receiving the email, the vendor (e.g., John Smith) may either accept the negotiation items included in the created bid sheet, or counter propose with alternative negotiation items via responding to the email. In situations where the vendor responds with counter-offer negotiation items, upon receiving the email response from the vendor, the vendor profile management system may automatically identify the counter-offer negotiation items and associate them with the vendor profile of John Smith. The user may view and respond based on the counter-offer negotiation items in a user interface generated by the vendor profile management system.

FIG. 6 illustrates an example graphical user interface 600 generated by an example vendor profile management system during operation, according to various embodiments of the present disclosure. As shown, the example graphical user interface 600 represents a report that includes a partially displayed list (e.g., list 602) of all ongoing and past products, services, and projects that have been negotiated with vendors. The report may further include the amount of total savings 606, a number of the total contract 608, a number of the in-progress contract 610, a number of the complete contracts 612, available inventory items, and the associated prices (not shown). A user may enter filtering criteria via a number of entry elements in the display section 604 to further narrow down the list shown in the report.

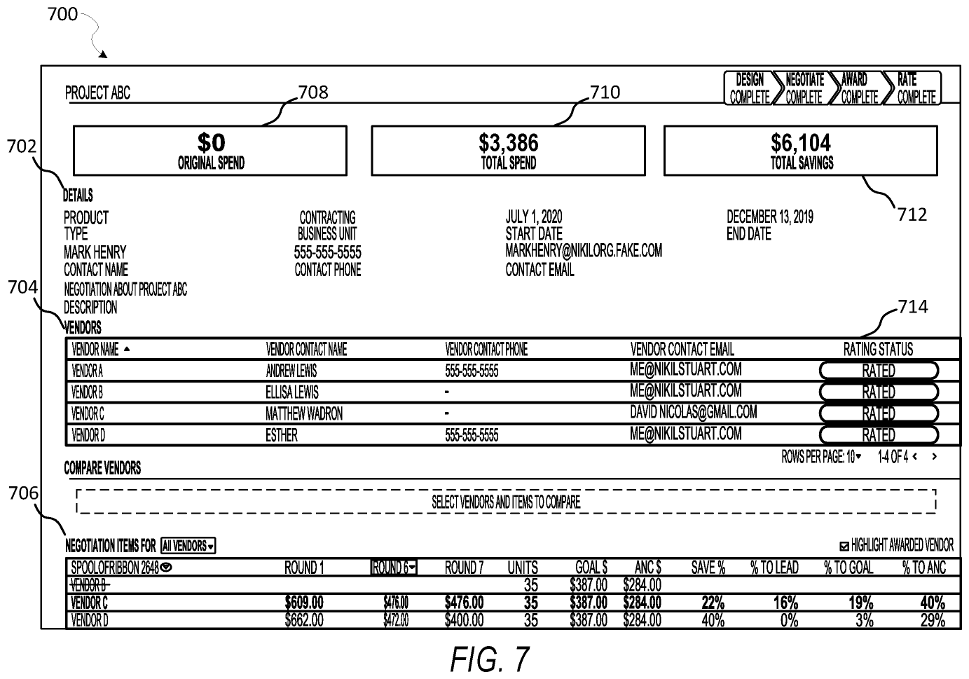

FIG. 7 illustrates an example graphical user interface 700 generated by an example vendor profile management system during operation, according to various embodiments of the present disclosure. As shown, the example graphical user interface 700 represents a project report associated with a project ABC. The project report includes project details 702, vendor information 704, negotiation items 706, an amount of original spend 708, an amount of total spend 710, and an amount of total savings 712. The vendor information 704 includes a list of vendors (e.g., vendors A-D) that participated in the bid negotiations. A vendor profile (not shown) may be displayed in response to a user selection of any of the listed vendors. The vendor information 704 further includes rating status 714 of each listed vendor. In various embodiments, a user may rate a vendor via one or more user inputs. A rating may alternatively be generated based on vendor performance data available to the vendor profile management system. As illustrated in FIG. 7, negotiation items 706 include price terms and unit numbers associated with each vendor according to the negotiation terms exchanged in each round of negotiation. Real-time ratings allow users to recognize and fix key vendor issues immediately.

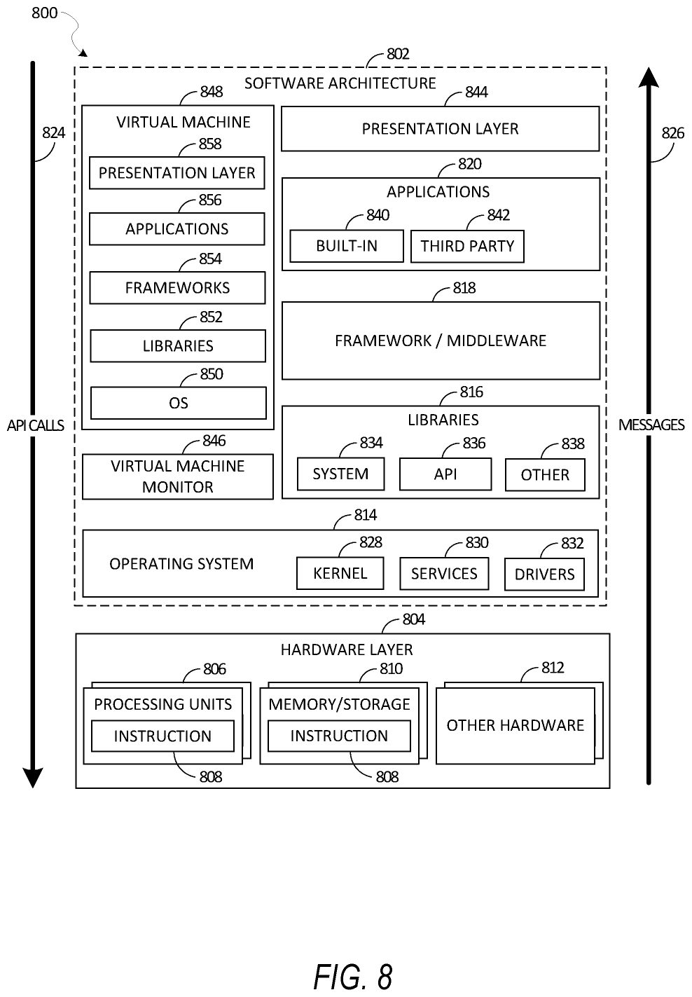

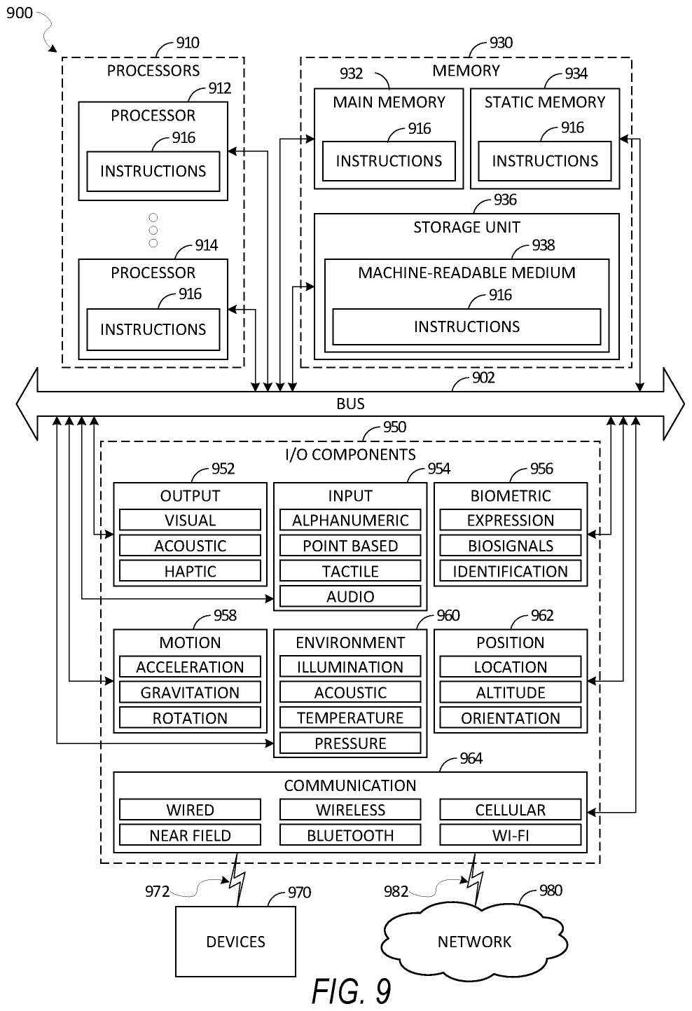

FIG. 8 is a block diagram illustrating an example of a software architecture 802 that may be installed on a machine, according to some example embodiments. FIG. 8 is merely a non-limiting example of software architecture, and it will be appreciated that many other architectures may be implemented to facilitate the functionality described herein. The software architecture 802 may be executing on hardware such as a machine 900 of FIG. 9 that includes, among other things, processors 910, memory 930, and input/output (I/O) components 950. A representative hardware layer 804 is illustrated and can represent, for example, the machine 900 of FIG. 9. The representative hardware layer 804 comprises one or more processing units 806 having associated executable instructions 808. The executable instructions 808 represent the executable instructions of the software architecture 802. The hardware layer 804 also includes memory or storage modules 810, which also have the executable instructions 808. The hardware layer 804 may also comprise other hardware 812, which represents any other hardware of the hardware layer 804, such as the other hardware illustrated as part of the machine 900.

In the example architecture of FIG. 8, the software architecture 802 may be conceptualized as a stack of layers, where each layer provides particular functionality. For example, the software architecture 802 may include layers such as an operating system 814, libraries 816, frameworks/middleware 818, applications 820, and a presentation layer 844. Operationally, the applications 820 or other components within the layers may invoke API calls 824 through the software stack and receive a response, returned values, and so forth (illustrated as messages 826) in response to the API calls 824. The layers illustrated are representative in nature, and not all software architectures have all layers. For example, some mobile or special-purpose operating systems may not provide a frameworks/middleware 818 layer, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), WiFi® drivers, audio drivers, power management drivers, and so forth depending on the hardware configuration.

The libraries 816 may provide a common infrastructure that may be utilized by the applications 820 and/or other components and/or layers. The libraries 816 typically provide functionality that allows other software modules to perform tasks in an easier fashion than by interfacing directly with the underlying operating system 814 functionality (e.g., kernel 828, services 830, or drivers 832). The libraries 816 may include system libraries 834 (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks 818 (also sometimes referred to as middleware) may provide a higher-level common infrastructure that may be utilized by the applications 820 or other software components/modules. For example, the frameworks 818 may provide various graphical user interface functions, high-level resource management, high-level location services, and so forth. The frameworks 818 may provide a broad spectrum of other APIs that may be utilized by the applications 820 and/or other software components/modules, some of which may be specific to a particular operating system or platform.

The applications 820 include built-in applications 840 and/or third-party applications 842. Examples of representative built-in applications 840 may include, but are not limited to, a home application, a contacts application, a browser application, a book reader application, a location application, a media application, a messaging application, or a game application.

The third-party applications 842 may include any of the built-in applications 840, as well as a broad assortment of other applications. In a specific example, the third-party applications 842 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 842 may invoke the API calls 824 provided by the mobile operating system such as the operating system 814 to facilitate functionality described herein.

The applications 820 may utilize built-in operating system functions (e.g., kernel 828, services 830, or drivers 832), libraries (e.g., system libraries 834, API libraries 836, and other libraries 838), or frameworks/middleware 818 to create user interfaces to interact with users of the system. Alternatively, or additionally, in some systems, interactions with a user may occur through a presentation layer, such as the presentation layer 844. In these systems, the application/module “logic” can be separated from the aspects of the application/module that interact with the user.

Some software architectures utilize virtual machines. In the example of FIG. 8, this is illustrated by a virtual machine 848. The virtual machine 848 creates a software environment where applications/modules can execute as if they were executing on a hardware machine (e.g., the machine 900 of FIG. 9). The virtual machine 848 is hosted by a host operating system (e.g., the operating system 814) and typically, although not always, has a virtual machine monitor 846, which manages the operation of the virtual machine 848 as well as the interface with the host operating system (e.g., the operating system 814). A software architecture executes within the virtual machine 848, such as an operating system 850, libraries 852, frameworks/middleware 854, applications 856, or a presentation layer 858. These layers of software architecture executing within the virtual machine 848 can be the same as corresponding layers previously described or may be different.

FIG. 9 illustrates a diagrammatic representation of a machine 900 in the form of a computer system within which a set of instructions may be executed for causing the machine 900 to perform any one or more of the methodologies discussed herein, according to an embodiment. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example, the instructions 916 may cause the machine 900 to execute the method 300 described above with respect to FIG. 3 and the method 400 described above with respect to FIG. 4. The instructions 916 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an embodiment, the processors 910 (e.g., a hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 912 and a processor 914 that may execute the instructions 916. The term “processor” is intended to include multi-core processors that may comprise two or more independent processors (sometimes referred to as “cores”) that may execute instructions contemporaneously. Although FIG. 9 shows multiple processors 910, the machine 900 may include a single processor with a single core, a single processor with multiple cores (e.g., a multi-core processor), multiple processors with a single core, multiple processors with multiples cores, or any combination thereof.

The memory 930 may include a main memory 932, a static memory 934, and a storage unit 936 including machine-readable medium 938, each accessible to the processors 910 such as via the bus 902. The main memory 932, the static memory 934, and the storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion, and the grouping is in no way limiting. In various embodiments, the I/O components 950 may include output components 952 and input components 954. The output components 952 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the I/O components 950 may include biometric components 956, motion components 958, environmental components 960, or position components 962, among a wide array of other components. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 962 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as location via Internet Protocol (IP) geolocation, location via Wi-Fi® signal triangulation, location via detecting an NFC beacon signal that may indicate a particular location, and so forth.

Certain embodiments are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In some embodiments, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines 900 including processors 910), with these operations being accessible via a network (e.g., the Internet) and via one or more appropriate interfaces (e.g., an API). In certain embodiments, for example, a client device may relay or operate in communication with cloud computing systems, and may access circuit design information in a cloud environment.

The performance of certain of the operations may be distributed among the processors, not only residing within a single machine 900, but deployed across a number of machines 900. In some example embodiments, the processors 910 or processor-implemented modules are located in a single geographic location (e.g., within a home environment, an office environment, or a server farm). In other example embodiments, the processors or processor-implemented modules are distributed across a number of geographic locations.

### Executable Instructions and Machine Storage Medium

The various memories (i.e., 930, 932, 934, and/or the memory of the processor(s) 910) and/or the storage unit 936 may store one or more sets of instructions 916 and data structures (e.g., software) embodying or utilized by any one or more of the methodologies or functions described herein. These instructions (e.g., the instructions 916), when executed by the processor(s) 910, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 916 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various embodiments, one or more portions of the network 980 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UNITS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 970. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” “without limitation” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A method comprising:
receiving, by a hardware processing device, a request to transmit a negotiation invitation to a vendor, the request including information that describes a negotiation item;
generating, by the hardware processing device, a Uniform Resource Locator (URL) based on the request, the URL being associated with a web resource that includes a web-based entry element;
transmitting, by the hardware processing device, the URL to the vendor via an email;
receiving, by the hardware processing device, a return value of the negotiation item from the vendor via the web-based entry element;
causing, by the hardware processing device, presentation of the return value of the negotiation item on a user interface of a device; and
generating, by the hardware processing device, a vendor profile based at least on the negotiation item and the return value of the negotiation item.

2. The method of claim 1, further comprising:
receiving, by the hardware processing device, historical data that includes a plurality of historical negotiation items associated with the vendor; and
updating, by the hardware processing device, the vendor profile based on the historical data.

3. The method of claim 1, further comprising:
generating, by the hardware processing device, a report based on the vendor profile, the report including information that describes a negotiation history of a project associated with the vendor; and
causing, by the hardware processing device, presentation of the report on the user interface of the device.

4. The method of claim 3, further comprising:
dynamically updating, by the hardware processing device, the vendor profile and the report based on a further negotiation invitation transmitted to the vendor and a further return value of a further negotiation item received from the vendor; and
dynamically causing, by the hardware processing device, presentation of an updated vendor profile on the user interface of the device.

5. The method of claim 3, wherein the report further comprises at least one of: one or more ratings of the vendor and a number of awarded contracts, an amount of total savings, and an amount of total spending.

6. The method of claim 1, further comprising:
receiving, by the hardware processing device, a user input that includes a tag representing a characteristic of the vendor;
identifying, by the hardware processing device, a vendor profile associated with the vendor; and
associating, by the hardware processing device, the tag with the vendor profile.

7. The method of claim 6, further comprising:
receiving, by the hardware processing device, a request to search for all vendors sharing the characteristic of the vendor;
generating, by the hardware processing device, a first list of vendors based on the tag representing the characteristic of the vendor; and
causing, by the hardware processing device, presentation of the first list of vendors on the user interface of the device.

8. The method of claim 1, further comprising:
generating, by the hardware processing device, a second user interface on the device, the user interface being a first user interface, the second user interface including a set of entry elements, each of the set of entry elements being configured to receive a filter criterion of negotiation events.

9. The method of claim 8, further comprising:
receiving, by the hardware processing device, a first user input that includes a value of a first filter criterion via a first entry element from the set of entry elements; and
generating, by the hardware processing device, a first set of negotiation events including filtering all negotiation events based on the first filter criterion.

10. The method of claim 9, further comprising:
causing, by the hardware processing device, presentation of the first set of negotiation events on the second user interface on the device.

11. A system comprising:
a memory storing instructions; and
one or more hardware processors communicatively coupled to the memory and configured by the instructions to perform operations comprising:
receiving a request to transmit a negotiation invitation to a vendor, the request including information that describes a negotiation item;
generating a Uniform Resource Locator (URL) based on the request, the URL being associated with a web resource that includes a web-based entry element;
transmitting the URL to the vendor via an email;
receiving a return value of the negotiation item from the vendor via the web-based entry element;
causing presentation of the return value of the negotiation item on a user interface of a device; and
generating a vendor profile based at least on the negotiation item and the return value of the negotiation item.

12. The system of claim 11, wherein the operations further comprise:
receiving historical data that includes a plurality of historical negotiation items associated with the vendor; and
updating the vendor profile based on the historical data.

13. The system of claim 11, wherein the operations further comprise:
generating a report based on the vendor profile, the report including information that describes a negotiation history of a project associated with the vendor; and
causing presentation of the report on the user interface of the device.

14. The system of claim 13, wherein the operations further comprise:
dynamically updating the vendor profile and the report based on a further negotiation invitation transmitted to the vendor and a further return value of a further negotiation item received from the vendor; and
dynamically causing presentation of an updated vendor profile on the user interface of the device.

15. The system of claim 13, wherein the report further comprises at least one of: one or more ratings of the vendor and a number of awarded contracts, an amount of total savings, and an amount of total spending.

16. The system of claim 11, wherein the operations further comprise:
receiving a user input that includes a tag representing a characteristic of the vendor;
identifying a vendor profile associated with the vendor; and
associating the tag with the vendor profile.

17. The system of claim 16, wherein the operations further comprise:
receiving a request to search for all vendors sharing the characteristic of the vendor;
generating a first list of vendors based on the tag representing the characteristic of the vendor; and
causing presentation of the first list of vendors on the user interface of the device.

18. The system of claim 11, wherein the user interface is a first user interface, and the operations further comprise:
generating a second user interface on the device, the second user interface including a set of entry elements, each of the set of entry elements being configured to receive a filter criterion of negotiation events.

19. The system of claim 18, wherein the operations further comprise:
receiving a first user input that includes a value of a first filter criterion via a first entry element from the set of entry elements; and
generating a first set of negotiation events including filtering all negotiation events based on the first filter criterion.

20. A non-transitory computer-readable medium comprising instructions that, when executed by a hardware processor of a device, cause the device to perform operations comprising:
receiving a request to transmit a negotiation invitation to a vendor, the request including information that describes a negotiation item;
generating a Uniform Resource Locator (URL) based on the request, the URL being associated with a web resource that includes a web-based entry element;
transmitting the URL to the vendor via an email;
receiving a return value of the negotiation item from the vendor via the web-based entry element;
causing presentation of the return value of the negotiation item on a user interface of a device; and
generating a vendor profile based at least on the negotiation item and the return value of the negotiation item.
